(19) United States
(12) Patent Application Publication
(10) Pub. No.: US 2021/0376967 A1
(43) Pub. Date: Dec. 2, 2021

(54) METHOD AND APPARATUS FOR TRANSMITTING AND RECEIVING FEEDBACK SIGNAL IN COMMUNICATION SYSTEM

(71) Applicant: ELECTRONICS AND TELECOMMUNICATIONS RESEARCH INSTITUTE, Daejeon (KR)

(72) Inventors: Seok Ki AHN, Daejeon (KR); Sung Ik PARK, Daejeon (KR)

(73) Assignee: ELECTRONICS AND TELECOMMUNICATIONS RESEARCH INSTITUTE, Daejeon (KR)

(21) Appl. No.: 17/335,934

(22) Filed: Jun. 1, 2021

(30) Foreign Application Priority Data
Jun. 2, 2020 (KR) 10-2020-0066437
May 26, 2021 (KR) 10-2021-0067859

(51) Int. Cl. H04L 1/18; H04W 72/00; H04W 72/12; H04W 72/04

(52) U.S. Cl. CPC H04L 1/1896; H04W 72/005; H04L 1/1819; H04W 72/0413; H04W 72/1289

(57) ABSTRACT

A feedback signal transmission method performed by a first terminal in a communication system may comprise receiving first configuration information for a first PUCCH format for feedback for a unicast transmission scheme and a second PUCCH format for feedback for a multicast transmission scheme from a first base station; receiving first DCI for scheduling first downlink data; receiving the first downlink data; and performing a feedback operation for the first down data, wherein the receiving of the first DCI and the performing of the feedback operation for the first downlink data are performed differently for a case when the first downlink data is downlink data transmitted according to the unicast transmission scheme and a case when the first downlink data is downlink data transmitted according to the multicast transmission scheme.

### CROSS-REFERENCE TO RELATED APPLICATIONS

This application claims priority to Korean Patent Applications No. 10-2020-0066437 filed on Jun. 2, 2020 and No. 10-2021-0067859 filed on May 26, 2021 with the Korean Intellectual Property Office (KIPO), the entire contents of which are hereby incorporated by reference.

### BACKGROUND

### 1. Technical Field

The present disclosure relates to a method and an apparatus for transmitting and receiving a feedback signal in a wireless communication system, and more specifically, to a method and an apparatus for configuring a feedback scheme for downlink signal transmission, and transmitting and receiving a feedback signal according to the configured feedback scheme.

2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

The 5G communication system (hereinafter, new radio (NR) communication system) using a higher frequency band (e.g., a frequency band of 6GHz or above) than a frequency band (e.g., a frequency band of 6GHz or below) of the 4G communication system (e.g., long term evolution (LTE) communication system) is being considered for processing of wireless data soaring after commercialization of the 4G communication system.

In a communication system, transmission of a signal from one transmitting node to one receiving node may be referred to as ‘point-to-point (P2P) transmission’ or ‘one-to-one transmission’, and transmission of a signal from one transmitting node to multiple receiving nodes may be referred to as ‘point-to-multipoint (P2MP) transmission’ or ‘one-to-many transmission’. The P2P transmission or one-to-one transmission may be performed according to a unicast scheme. The P2MP transmission or one-to-many transmission may be performed according to a transmission scheme such as multicast, groupcast, or broadcast.

Simultaneous transmissions of the same signal (e.g., control signal, data, etc.) from one upper node (e.g., base station) to a plurality of lower nodes (e.g., terminals) using a common resource may be referred to multicast downlink transmission. In case of the multicast downlink transmission, a downlink signal may be transmitted through a common downlink resource. Meanwhile, feedback signals (e.g., hybrid automatic repeat request (HARQ) signals) transmitted by the respective lower nodes for the multicast downlink transmission may be received through independent uplink resources according to the same or different feedback schemes. In the multicast downlink transmission, a procedure of configuring the feedback scheme(s) and performing feedback for the upper node and lower nodes may need to be performed in a different manner than in unicast downlink transmission. In the multicast downlink transmission, techniques for efficiently configuring feedback scheme(s) and performing feedback may be required.

### SUMMARY

In order to solve the above-identified problems, exemplary embodiments of the present disclosure are directed to providing a method and an apparatus for transmitting and receiving a feedback signal in order to efficiently perform feedback scheme configuration and feedback signal transmission and reception.

According to an exemplary embodiment of the present disclosure for achieving the above-described objective, a feedback signal transmission method performed by a first terminal in a communication system may comprise: receiving first configuration information from a first base station in the communication system, the first configuration information including configuration information of a first physical uplink control channel (PUCCH) format for feedback for a unicast transmission scheme and configuration information of a second PUCCH format for feedback for a multicast transmission scheme; receiving first downlink control information (DCI) for scheduling first downlink data from the first base station; receiving the first downlink data from the first base station based on the first configuration information and the first DCI; and performing a feedback operation for the first down data to the first base station based on the first configuration information and the first DCI, wherein the receiving of the first DCI and the performing of the feedback operation for the first downlink data are performed differently for a case when the first downlink data is downlink data transmitted according to the unicast transmission scheme and a case when the first downlink data is downlink data transmitted according to the multicast transmission scheme.

The performing of the feedback operation for the first downlink data may comprise: when the first downlink data is downlink data transmitted according to the multicast transmission scheme, identifying information of resource blocks (RBs) of a first PUCCH allocated to the first terminal among a plurality of PUCCH RBs allocated by the first DCI separately to a plurality of terminals included in a first terminal group including the first terminal; and transmitting a first feedback signal for the first downlink data to the first base station through the RBs of the first PUCCH.

The second PUCCH format may be defined to include a first information element (IE) allowing a PUCCH to be allocated to a plurality of RBs.

The performing of the feedback operation for the first downlink data may comprise: when the first downlink data is downlink data transmitted according to the multicast transmission scheme, identifying information of resources of a first PUCCH allocated to a first subgroup including the first terminal among a plurality of PUCCH resources allocated by the first DCI separately to a plurality of subgroups into which a first terminal group including the first terminal is divided; and transmitting a first feedback signal for the first downlink data to the first base station through the resources of the first PUCCH.

The receiving of the first DCI may comprise identifying whether a new data indicator (NDI) field of the first DCI indicates whether downlink data transmitted according to the unicast transmission scheme is initial transmission data or whether downlink data transmitted according to the multicast transmission scheme is initial transmission data based on a DCI format of the first DCI or a type of a radio network temporary identifier (RNTI) scrambling a cyclic redundancy check (CRC) of the first DCI.

The receiving of the first DCI may comprise identifying whether a hybrid automatic repeat request (HARQ) process number (HPN) field of the first DCI indicates information related to a HARQ process(es) of downlink data transmitted according to the unicast transmission scheme or information related to a HARQ process(es) of downlink data transmitted according to the multicast transmission scheme based on a HPN value indicated by the HPN field of the first DCI, wherein n HPN values among N HPN values indicatable by the HPN field may be used to indicate the information related to the HARQ process(es) of downlink data transmitted according to the unicast transmission scheme, and remaining (N-n) HPN values may be used to indicate the information related to the HARQ process(es) of downlink data transmitted according to the multicast transmission scheme.

The receiving of the first DCI may comprise, when the first downlink data is downlink data transmitted according to the multicast transmission scheme, obtaining, through a value of a downlink assignment index (DAI) field of the first DCI, a counter DAI (c-DAI) value and a total DAI (t-DAI) value reflecting a result of downlink data scheduling according to the unicast transmission scheme and a result of downlink data scheduling according to the multicast transmission scheme up to a time when the first downlink data is scheduled.

The first DCI may correspond to a DCI defined not to include a DAI field when the first downlink data is downlink data transmitted according to the multicast transmission scheme.

The method may further comprise, when the first downlink data is downlink data transmitted according to the unicast transmission scheme, receiving, from the first base station, second DCI for scheduling second downlink data to be transmitted according to the multicast transmission scheme; receiving, from the first base station, the second downlink data based on the first configuration information and the second DCI; and performing a feedback operation for the second downlink data to the first base station based on the first configuration information and the second DCI, wherein when a timing of a first PUCCH resource indicated by the first DCI for a feedback procedure for the first downlink data transmitted according to the unicast transmission scheme is identical to a timing of a second PUCCH resource indicated by the second DCI for a feedback procedure for the second downlink data transmitted according to the multicast transmission scheme, the feedback operation for the first downlink data and the feedback operation for the second downlink data may be both performed through a first PUCCH resource.

In the performing of the feedback operation for the second downlink data, when the first terminal is indicated a negative acknowledgement (NACK)-only HARQ scheme as a feedback scheme for performing a feedback procedure for downlink data transmitted according to the multicast transmission scheme, the feedback operation for the second downlink data may be performed according to an ACK/NACK HARQ scheme instead of the indicated NACK-only HARQ scheme.

The performing of the feedback operation for the first down data may comprise: when the first downlink data is downlink data transmitted according to the multicast transmission scheme, determining whether feedback signal transmission for the first downlink data is required based on a first feedback scheme indicated by the first base station before transmission of the first downlink data and whether the first downlink data is normally received; generating a first feedback signal for the first downlink data when the feedback signal transmission for the first downlink data is required; and transmitting the first feedback signal to the first base station, wherein the first feedback scheme may be indicated selectively among an ACK/NACK HARQ scheme, NACK-only HARQ scheme, ACK-only HARQ scheme, and no-HARQ scheme through the first configuration information, the first DCI, or a radio resource control (RRC) message controlling scheduling information of the first downlink data.

According to another exemplary embodiment of the present disclosure for achieving the above-described objective, a feedback signal reception method performed by a first base station in a communication system may comprise: transmitting first configuration information to a plurality of terminals in the communication system, the first configuration information including configuration information of a first physical uplink control channel (PUCCH) format for feedback for a unicast transmission scheme and configuration information of a second PUCCH format for feedback for a multicast transmission scheme; transmitting first downlink control information (DCI) for scheduling first downlink data to at least one terminal among the plurality of terminals; transmitting the first downlink data to the at least one terminal based on the first configuration information and the first DCI; and receiving at least one feedback signal for the first downlink data from the at least one terminal based on the first configuration information and the first DCI, wherein the transmitting of the first DCI and the receiving of the at least one feedback signal are performed in difference schemes for a case when the first downlink data is downlink data transmitted according to the unicast transmission scheme and a case when the first downlink data is downlink data transmitted according to the multicast transmission scheme.

The first DCI may be configured to allocate a plurality of PUCCH resource blocks (RBs) to be separately allocated to each of a plurality of terminals included in a first terminal group of the communication system when the first downlink data is downlink data transmitted according to the multicast transmission scheme, and the receiving of the at least one feedback signal may comprise: identifying the plurality of PUCCH RBs allocated based on the first DCI; and receiving the at least one feedback signal for the first downlink data from at least a part of the plurality of terminals included in the first terminal group through at least a part of the plurality of PUCCH RBs.

The second PUCCH format may be defined to include a first information element (IE) allowing a PUCCH to be allocated to a plurality of RBs.

DCI for scheduling downlink data transmitted according to the unicast transmission scheme and DCI for scheduling downlink data transmitted according to the multicast transmission scheme may be configured based on different DCI formats, and the first base station may operate new data indicator (NDI) fields of the DCIs configured based on different DCI formats independently from each other.

In DCI for scheduling downlink data transmitted according to the unicast transmission scheme and downlink data transmitted according to the multicast transmission scheme, the first base station may use n hybrid automatic repeat request (HARQ) process number (HPN) values among N HPN values indicatable by a HPN field to indicate information related to a HARQ process(es) of the downlink data transmitted according to the unicast transmission scheme, and may use remaining (N-n) HPN values to indicate information related to a HARQ process(es) of the downlink data transmitted according to the multicast transmission scheme.

The first base station may operate HPN fields of DCI for scheduling downlink data transmitted according to the unicast transmission scheme and DCI for scheduling downlink data transmitted according to the multicast transmission scheme independently from each other.

The transmitting of the first DCI may comprise: when the first downlink data is downlink data transmitted according to the multicast transmission scheme, identifying a result of downlink data scheduling according to the unicast transmission scheme and a result of downlink data scheduling according to the multicast transmission scheme up to a time when the first downlink data is scheduled; and determining a counter downlink assignment index (c-DAI) value and a total DAI (t-DAI) value of a DAI field of the first DCI by reflecting the identified result of downlink data scheduling according to the unicast transmission scheme and the identified result of downlink data scheduling according to the multicast transmission scheme.

The method may further comprise, when the first downlink data is downlink data transmitted to the first terminal according to the unicast transmission scheme, transmitting, to a first terminal group including the first terminal, second DCI for scheduling second downlink data to be transmitted according to the multicast transmission scheme; transmitting, to a plurality of terminals included in the first terminal group, the second downlink data based on the first configuration information and the second DCI; and receiving at least one feedback signal for the second downlink data from at least a part of the plurality of terminals included in the first terminal group based on the first configuration information and the second DCI, wherein when a timing of a first PUCCH resource indicated by the first DCI for a feedback procedure for the first downlink data transmitted according to the unicast transmission scheme is identical to a timing of a second PUCCH resource indicated by the second DCI for a feedback procedure for the second downlink data transmitted according to the multicast transmission scheme, the at least one feedback signal for the first downlink data and the at least one feedback signal for the second downlink data may be received through a first PUCCH resource.

The first base station may indicate feedback scheme(s) to a plurality of terminal groups through the first configuration information, a plurality of DCIs scheduling a plurality of downlink data units, or a plurality of radio resource control (RRC) messages controlling scheduling information of the plurality of downlink data units before transmitting the plurality of downlink data units to the plurality of terminal groups, the feedback scheme(s) may be selected among an ACK/NACK HARQ scheme, NACK-only HARQ scheme, ACK-only HARQ scheme, and no-HARQ scheme, and the feedback scheme(s) may be indicated independently to each of the plurality of terminal groups or indicated identically to at least two of the plurality of terminal groups.

According to exemplary embodiments of the present disclosure, a base station may use either the unicast transmission scheme or multicast transmission scheme, or may use both the unicast transmission scheme and multicast transmission scheme when transmitting downlink data to a terminal. The base station may inform the terminal of information for the terminal to perform a feedback operation on the downlink data transmitted according to the unicast transmission scheme and/or multicast transmission scheme through DCI for scheduling the downlink data transmitted to the terminal. Accordingly, the feedback operation between the base station and the terminal supporting the unicast transmission scheme and/or the multicast transmission scheme can be efficiently performed.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIGS. 3A and 3B are conceptual diagrams for describing an exemplary embodiment of a control plane and a user plane of a radio protocol in a communication system.

FIG. 4 is a conceptual diagram illustrating an exemplary embodiment of a mapping structure between downlink channels in a base station of a communication system.

FIG. 5 is a conceptual diagram illustrating an exemplary embodiment of an operation for transmitting and receiving a feedback signal in a communication system.

FIG. 6 is a sequence chart illustrating an exemplary embodiment of a method of transmitting and receiving a feedback signal between a first communication node and a second communication node in a communication system.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein. Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present specification, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present specification, a terminal may refer to a mobile station, mobile terminal, subscriber station, portable subscriber station, user equipment, an access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B, evolved node B (eNodeB), base transceiver station, mobile multihop relay (MMR)-BS, or the like, and may include all or part of functions of the base station, access point, radio access station, nodeB, eNodeB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

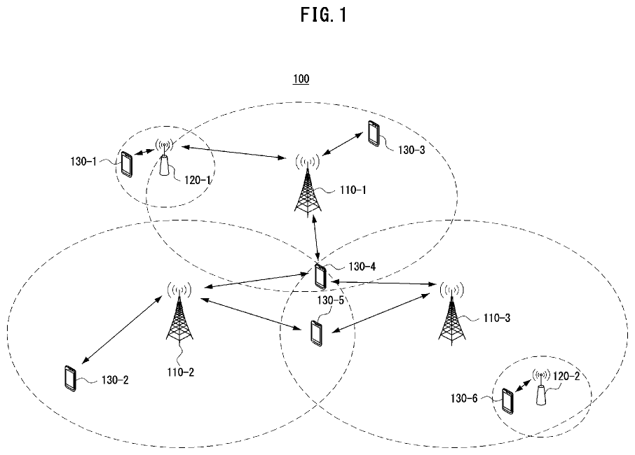

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

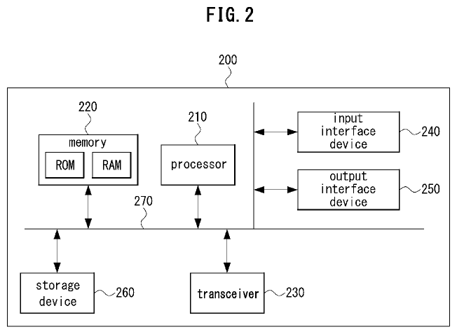

FIG. 2 is a block diagram illustrating a first embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell.

The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods and apparatuses for transmitting and receiving feedback signals in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

Meanwhile, in the communication system, a base station may perform all functions (e.g., remote radio transmission and reception function, baseband processing function, and the like) of a communication protocol. Alternatively, the remote radio transmission and reception function among all the functions of the communication protocol may be performed by a transmission reception point (TRP) (e.g., flexible TRP (f-TRP)), and the baseband processing function among all the functions of the communication protocol may be performed by a baseband unit (BBU) block. The TRP may be a remote radio head (RRH), a radio unit (RU), a transmission point (TP), or the like. The BBU block may include at least one BBU or at least one digital unit (DU). The BBU block may be referred to as a ‘BBU pool’, a ‘centralized BBU’, or the like. The TRP may be connected to the BBU block via a wired fronthaul link or a wireless fronthaul link. A communication system composed of backhaul links and fronthaul links may be as follows. When a functional-split scheme of the communication protocol is applied, the TRP may selectively perform some functions of the BBU or some functions of a medium access control (MAC) layer or a radio link control (RLC) layer.

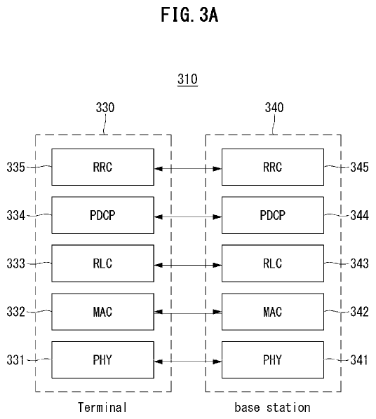

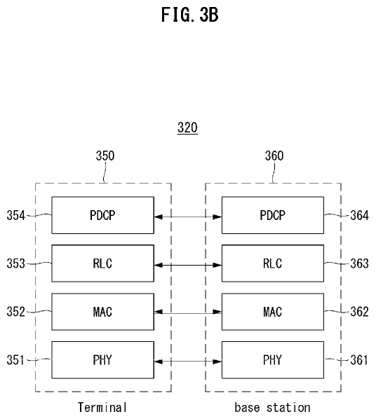

FIGS. 3A and 3B are conceptual diagrams for describing an exemplary embodiment of a control plane and a user plane of a radio protocol in a communication system.

In a radio connection section between communication nodes, radio interface protocols may be defined. For example, the radio interface protocol may be divided into a physical layer, a data link layer, and a network layer which are configured vertically.

The radio interface protocol may be divided into a control plane 310 shown in FIG. 3A and a user plane 320 shown in FIG. 3B. The control plane 310 may be a plane for delivering a control signal. The control signal may be referred to as a signaling signal. The user plane 320 may be a plane for transmitting user data.

Referring to FIGS. 3A and 3B, the radio interface protocol may generally include three lower layers of the Open System Interconnection (OSI) reference model, which is well known in the technology domain of communication systems. For example, the first layer L1 may include physical (PHY) layers 331 and 341, or 351 and 361. The second layer L2 may include medium access control (MAC) layers 332 and 342, or 352 and 362, radio link control (RLC) layers 333 and 343, or 353 and 363, and packet data convergence protocol (PDCP) layers 334 and 344, or 354 and 364. In addition, the third layer L3 may include radio resource control (RRC) layers 335 and 345. A pair of the radio interface protocols may exist between a terminal 330 or 350 and a base station 340 or 360, and may be responsible for data transmission of the radio interface. However, these are only an example for convenience of description, and exemplary embodiments of the present disclosure are not limited thereto. For example, in an exemplary embodiment of the communication system, only some of the layers shown in FIGS. 3A and 3B may be used, or layers not shown in FIGS. 3A and 3B may be additionally defined and used.

The PHY layers 331 and 341, or 351 and 361, which belong to the first layer, may provide information transfer services to the upper layers by using physical channels. The PHY layers 331 and 341, or 351 and 361 may be connected to the upper MAC layers 332 and 342, or 352 and 362 through transport channels. Data between the PHY layers 331 and 341, or 351 and 361 and the MAC layers 332 and 342, or 352 and 362 may move through the transport channels. The transport channel may be classified into a dedicated channel and a common channel according to whether or not the channel is shared. Data between different PHY layers may be moved through a physical channel using radio resources. That is, data between the PHY layer 331 or 351 of the terminal 330 or 350 and the PHY layer 341 or 361 of the base station 340 or 360 may move data a physical channel using radio resources.

The MAC layers 332 and 342, or 352 and 362 of the second layer may map a plurality of logical channels to a plurality of transport channels. Further, the MAC layers 332 and 342, or 352 and 362 may perform logical channel multiplexing functions of mapping a plurality of logical channels to one transport channel. The MAC layers 332 and 342, or 352 and 362 may be connected to the upper layer RLC layers 333 and 343, or 353 and 363 through logical channels. The logical channel may be classified into a control channel for transmitting information of the control plane 310 and a traffic channel for transmitting information of the user plane 320 according to a type of transmitted information.

The RLC layers 333 and 343, or 353 and 363 of the second layer may segment or concatenate data received from the upper layer to adjust a size of the data so that the size of the data is suitable for the lower layer to transmit the data through the radio section. In addition, the RLC layers 333 and 343, or 353 and 363 may provide a transparent mode (TM), an un-acknowledged mode (UM), and an acknowledged mode (AM) for satisfying various Quality of Service (QoS) requirements of respective radio bearers (RBs). In particular, an AM RLC may perform a retransmission function through an automatic repeat request (ARQ) function for reliable data transmission.

The PDCP layers 334 and 344 or 354 and 364 of the second layer may perform a header compression function. The header compression function may refer to a function of reducing a size of an IP packet header that is relatively large and contains unnecessary control information in order to increase transmission efficiency when transmitting the IP packet (e.g., internet protocol version 4 (IPv4) or IPv6) in the radio section with a small bandwidth. In other words, the header compression function may increase the transmission efficiency of the radio section by transmitting only necessary information in the header of the data.

Further, the PDCP layers 354 and 364, or 354 and 364 may perform a security function. The security function may include a ciphering function for preventing data interception by a third party and an integrity protection function for preventing data manipulation by a third party.

The RRC layers 335 and 345 of the third layer may be defined only in the control plane 310. The RRC layers 335 and 345 may perform controls on logical channels, transport channels, and physical channels, which are related to configuration, re-configuration, and release of radio bearers (RBs).

A radio bearer (RB) may refer to a logical path provided by the first and second layers of the radio protocol for data transmission between the terminal 330 or 350 and the base station 340 or 360. In general, configuration of the RB may refer to a process of specifying characteristics of radio protocol layers and channels required to provide a specific service, and configuring specific parameters and operation schemes thereof. The RB may be classified into a signaling RB (SRB) and a data RB (DRB). The SRB may be used as a path for transmitting an RRC message in the control plane 310. The DRB may be used as a path for transmitting user data in the user plane 320.

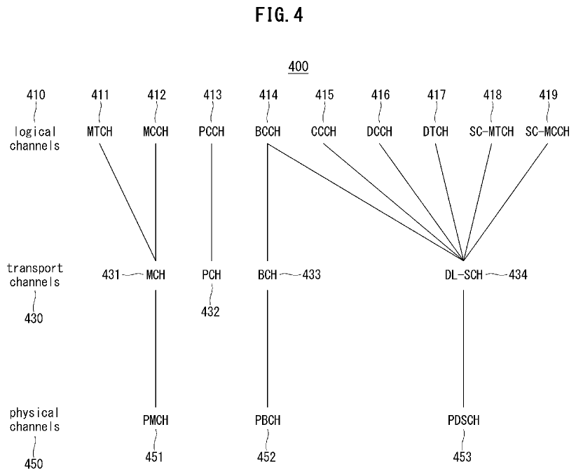

FIG. 4 is a conceptual diagram illustrating an exemplary embodiment of a mapping structure between downlink channels in a base station of a communication system.

FIG. 4 shows an exemplary embodiment of a mapping structure between downlink channels such as downlink logical channels 410, downlink transport channels 430, and downlink physical channels 450 in a base station of a communication system.

The downlink logical channels 410 may be channels managed by the MAC layer, and may be defined according to the type of information transmitted through them. The downlink logical channels 410 may be mapped to the downlink transport channels 430 by the MAC layer. The downlink transport channels 430 may be channels managed by the PHY layer, and may be mapped to the downlink physical channels 450.

The downlink logical channels 410 may include a multicast traffic channel (MTCH) 411, multicast control channel (MCCH) 412, paging control channel (PCCH) 413, broadcast control channel (BCCH) 414, common control channel (CCCH) 415, dedicated control channel (DCCH) 416, dedicated transport channel (DTCH) 417, single-cell multicast traffic channel (SC-MTCH) 418, single-cell multicast control channel (SC-MCCH) (419), and the like. The downlink transport channels 430 may include a multicast channel (MCH) 431, paging channel (PCH) 432, broadcast channel (BCH) 433, downlink shared channel (DL-SCH) 434, and the like. The downlink physical channels 450 may include a physical multicast channel (PMCH) 451, physical broadcast channel (PBCH) 452, physical downlink shared channel (PDSCH) 453, and the like. However, these are only an example for convenience of description, and exemplary embodiments of the present disclosure are not limited thereto. For example, in an exemplary embodiment of the communication system, only some of the channels shown in FIG. 4 may be used, or channels not shown in FIG. 4 may be additionally defined and used.

The MTCH 411 may refer to a logical channel for transmitting multimedia broadcast/multicast service (MBMS) traffic data. The MCCH 412 may refer to a logical channel for transmitting control information required for reception of the MTCH 411. The MTCH 411 and the MCCH 412 may be mapped to the MCH 431 among the downlink transport channels. The MCH may be mapped to the PMCH 451 among the downlink physical channels. The PCCH 413 may refer to a logical channel used for notifying a change in system information and paging a terminal whose cell-unit location is unknown to the network. The PCCH 413 may be mapped to the PCH 432 among the downlink transport channels.

The BCCH 414 may refer to a logical channel used by the base station to broadcast system information to arbitrary terminals. The BCCH 414 may be divided and mapped into the BCH 433 and the DL-SCH 434 among the downlink transport channels according to transmitted information. The BCH 433 and the DL-SCH 434 may be mapped to the PBCH 452 and the PDSCH 453, respectively. The BCCH 414 may include a master information block (MIB) transmitted through the PBCH 452, a system information block (SIB) transmitted through the PDSCH 453, and the like.

The CCCH 415 may refer to a logical channel used to transmit and receive control information (e.g., control information related to random access) between the terminal and the base station in a situation in which the terminal has not established an RRC connection with the base station. The DDCH 416 may refer to a logical channel used to transmit dedicated control information between the terminal and the base station in a situation in which the terminal has established an RRC connection with the base station. The DTCH 417 may refer to a logical channel used to transmit user traffic data of the terminal. The SC-MTCH 418 may refer to a logical channel used for single cell point-to-multipoint (SC-PTM) transmission. The SC-MCCH 419 may refer to a logical channel for transmitting control information required for reception of the SC-MTCH 418. The CCCH 415, DCCH 416, DTCH 417, SC-MTCH 418, and SC-MCCH 419 may be mapped to the DL-SCH 434 among the downlink transport channels.

Among the downlink logical channels, the MTCH 411, MCCH 412, PCCH 413, BCCH 414, and CCCH 415 may be shared by all terminals. Meanwhile, the DCCH 416 and the DTCH 417 may be dedicatedly allocated to each terminal. The DCCH 416 and DTCH 417 allocated to the terminal may be identified by logical channel identifiers (LCIDs). The terminal may have a plurality of DTCHs 417 according to QoS of traffic data to be provided through a service. For example, when the RRC layer of the base station determines to generate a new radio bearer for the terminal, the RRC layer may request the MAC layer to generate a new DTCH 417 along with information on a required QoS, and the MAC layer may schedule and transmit user traffic data to the terminal according to the QoS information provided from the RRC layer. Here, the QoS information may include a QoS class identifier (QCI), resource type, priority, packet delay parameter (e.g., packet delay budget (PDB)), packet loss error rate (PLER), and/or the like. Meanwhile, the SC-MTCH 418 and the SC-MCCH 419 may be allocated to a plurality of terminals.

When the base station transmits the same downlink data to a plurality of terminals at the same time, the one-to-many transmission scheme of transmitting the same data to the plurality of terminals using a common resource may be more efficient that the one-to-one transmission scheme of transmitting the downlink data to each of the plurality of terminal by allocating a separate resource to each terminal. Among various one-to-many transmission schemes, a scheme of transmitting the same data to a plurality of unspecified terminals may be referred to as a ‘broadcast scheme’ or the like. Among various one-to-many transmission schemes, a scheme of transmitting the same data to a group of terminals whose identities are confirmed may be referred to as a ‘multicast scheme’ or ‘groupcast scheme’.

In the one-to-many transmission scheme, for example, a multimedia broadcast multicast service (MBMS) of the 3G communication system, an evolved MBMS (eMBMS)/further evolved MBMS (FeMBMS) technology of the LTE communication system, or the like may be used. The MBMS technology may be largely classified into a multicast broadcast single frequency network (MBSFN) scheme and a single cell point to multipoint (SC-PTM) scheme. In terms of transmitting user data, the MBSFN scheme may transmit data to a plurality of terminals included in one or more cells through semi-static scheduling using a physical multicast channel (PMCH). Meanwhile, the SC-PTM scheme may transmit data to a plurality of terminals included in one cell through dynamic scheduling using a physical downlink shared channel (PDSCH).

In case of group communication such as multicast or groupcast, group communication service identification information (e.g., temporary mobile group identity (TMGI), etc.) may be defined to provide a service. The TMGI may be used to identify terminals interested in the group communication. In order to identify a control message for single-cell group communication using the SC-PTM, an identifier such as a single-cell radio network temporary identifier (SC-RNTI) may be defined. Each terminal may identify control information for the single cell group communication through the SC-RNTI. The terminal may be indicated a TMGI for identifying a specific group communication service through the base station or a server. Alternatively, the terminal may participate in group communication by receiving a TMGI of a service of interest in advance. For single cell group communication, the base station may define a group RNTI (G-RNTI) allocated to a corresponding group and allocate it to terminals in order to provide a specific group communication service. The G-RNTI may be configured to be associated with the TMGI or associated with a MBMS session ID or other identification information. In case of a service provided based on group communication, terminals interested in a service may identify and receive the desired service by identifying the TMGI. If the base station informs the terminal of a mapping relationship between G-RNTIs and TMGIs through a predetermined control signal, the terminal may identify a TMGI of a group communication service desired by the base station. Each terminal may receive data of the desired service through a PDSCH scheduled by a PDCCH scrambled by the identified TMGI and mapped G-RNTI.

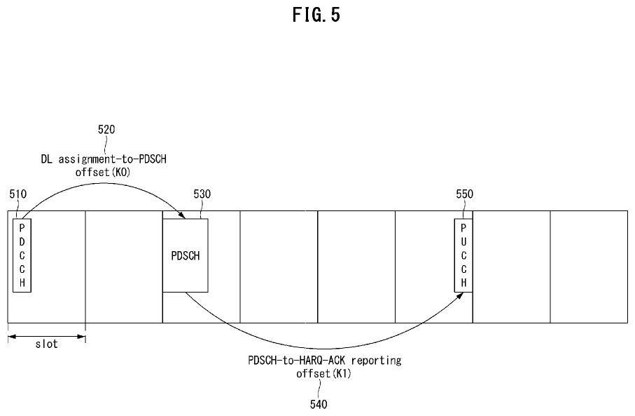

FIG. 5 is a conceptual diagram illustrating an exemplary embodiment of an operation for transmitting and receiving a feedback signal in a communication system.

Referring to FIG. 5, in an exemplary embodiment of the communication system, a feedback signal transmission/reception scheme may be used to improve reliability and efficiency of wireless communication. When a transmitting node of the communication system transmits a radio signal to a receiving node, the receiving node may transmit a feedback signal indicating information on whether or not the radio signal transmitted from the transmitting node is normally received to the transmitting node. For example, in an exemplary embodiment of the communication system, a feedback scheme based on a hybrid automatic repeat request (HARQ) protocol or a HARQ feedback scheme may be used.

In the HARQ protocol-based feedback scheme, when the receiving node succeeds in decoding a first signal transmitted from the transmitting node, the receiving node may transmit a feedback signal indicating that the first signal is normally received to the transmitting node. Here, the feedback signal indicating that the first signal is normally received may correspond to an ACK signal. On the other hand, when the decoding of the first signal transmitted from the transmitting node fails, the receiving node may transmit a feedback signal indicating that the first signal is not normally received to the transmitting node. Here, the feedback signal indicating that the first signal is not normally received may correspond to a NACK signal. When the transmitting node receives the NACK signal transmitted from the receiving node, the transmitting node may determine that the first signal is not normally received by the receiving node, and may perform retransmission of the first signal.

In an exemplary embodiment of the communication system, the receiving node may determine whether the first signal transmitted from the transmitting node is successfully received on a transport block (TB) basis. For example, when decoding fails or an error is detected in the decoding process for some of TBs constituting the first signal transmitted from the transmitting node, the receiving node may transmit a NACK signal for the corresponding TB. However, this is only an example for convenience of description, and exemplary embodiments of the present disclosure are not limited thereto. For example, the receiving node may determine whether the first signal transmitted from the transmitting node is successfully decoded on a code block (CB) basis. Alternatively, the receiving node may determine whether the first signal transmitted from the transmitting node is successfully decoded on a code block group (CBG) basis. Here, a CBG may be a group consisting of at least one CB, and may be smaller than a TB and greater than or equal to a CB. The receiving node may transmit a NACK signal for the CB or CBG when decoding fails or an error is detected in the decoding process for some of the CBs or CBGs of the first signal transmitted from the transmitting node.

In an exemplary embodiment of the communication system, an upper node (e.g., base station) may perform downlink signal transmission to a lower node (e.g., terminal). The lower node may transmit a feedback signal based on the HARQ protocol to the upper node as a feedback for transmission of a downlink signal from the upper node. Hereinafter, an exemplary embodiment of a feedback signal transmission/reception method will be described with an example of a situation in which the terminal performs feedback based on the HARQ protocol with respect to downlink data transmission performed by the base station to the terminal. However, this is only an example for convenience of description, and exemplary embodiments of the present disclosure are not limited thereto.

In an exemplary embodiment of the feedback signal transmission/reception method, the base station may transmit downlink data to the terminal through a physical downlink shared channel (PDSCH) 530. The terminal may transmit a HARQ response signal for the downlink data transmitted from the base station to the base station through a physical uplink control channel (PUCCH) 550. Alternatively, the terminal may transmit a HARQ response signal for the downlink data transmitted from the base station to the base station through a physical uplink shared channel (PUSCH). The terminal may transmit an ACK signal to the base station when the terminal succeeds in decoding the downlink data transmitted from the base station. On the other hand, the terminal may transmit a NACK signal to the base station when decoding of the downlink data transmitted from the base station fails. When receiving the NACK signal from the terminal, the base station may determine that the downlink data transmitted to the terminal is not normally received, and may perform retransmission of the transmitted downlink data.

Prior to transmitting the downlink data to the terminal through the PDSCH 530, the base station may transmit predetermined downlink control information (DCI) to the terminal through a physical downlink control channel (PDCCH) 510. The DCI transmitted by the base station to the terminal prior to the downlink data may be configured based on one of DCI formats defined according to the 3GPP technical specification. For example, the DCI transmitted from the base station to the terminal prior to the downlink data may be configured based on a DCI format 1_0, 1_1, 1_2, or the like. Alternatively, the DCI that the base station transmits to the terminal prior to the downlink data may have a separately defined structure to support an exemplary embodiment of the feedback signal transmission/reception method. The DCI transmitted by the base station to the terminal prior to the downlink data may be configured to include some or all of fields shown in Table 1.

TABLE 1

| Fields | Size (bits) |
|---|---|
| Identifier for DCI format | 1 |
| Frequency domain resource assignment | Variable |
| Time domain resource assignment | 4 |
| Modulation and coding scheme | 5 |
| New data indicator | 1 |
| HARQ process number | 4 |
| Downlink assignment index | 2 |
| PUCCH resource indicator | 3 |
| PDSCH-to-HARQ_feedback timing indicator | 3 |

In Table 1, the field ‘Identifier for DCI format’ may indicate a DCI format. The field ‘Frequency domain resource assignment’ may indicate allocation information of a frequency region in which downlink data is transmitted. The field ‘Time domain resource assignment’ may indicate allocation information of a time region in which the downlink data is transmitted. The field ‘Modulation and coding scheme’ may also referred to as an MCS field, and may indicate information related to a scheme in which the downlink data is modulated and encoded. The field ‘New data indicator’ may be also referred to as an NDI field, and may indicate whether the downlink data is initially transmitted or retransmitted. The field ‘HARQ process number’ may also referred to as an HPN field, and may indicate information such as identifier(s) or sequence number(s) for at least one HARQ process. The field ‘Downlink assignment index’ field may also referred to as a DAI field, and may indicate the number of PDSCHs transmitted in one slot. The field ‘PUCCH resource indicator’ may also referred to as a PRI field, and may indicate information on a resource of the PUCCH 550 to be used for the HARQ response. The field ‘PDSCH-to-HARQ_feedback timing indicator’ may indicate information such as a time interval or the number of slots from transmission of the PDSCH 530 until transmission of the HARQ.

The DCI that the base station transmits to the terminal prior to the downlink data may be configured to include at least some of one or more fields shown in Table 1. Each of the fields of the DCI that the base station transmits to the terminal prior to the downlink data may be configured to have the same size as or a different size from the size indicated in Table 1. The types of the fields included in the DCI that the base station transmits to the terminal prior to the downlink data may be determined differently according to the format of the DCI. Alternatively, the types of the fields included in the DCI may be determined differently according to a type of a radio network temporary identifier (RNTI) for scrambling a cyclic redundancy check (CRC). For example, the DCI format 1_0 may be configured to include different types of fields for each case in which the CRC is scrambled with a cell-RNTI (C-RNTI), random access (RA)-RNTI, temporary cell (TC)-RNTI, system information (SI)-RNTI, or paging (P)-RNTI. However, this is only an example for convenience of description, and exemplary embodiments of the present disclosure are not limited thereto.

The base station may inform the terminal of one or more pieces of control information related to first downlink data to be transmitted to the terminal by transmitting first DCI to the terminal through the PDCCH 510. For example, the first DCI transmitted by the base station to the terminal through the PDCCH 510 may include information of a first offset 520. Here, the first offset 520 may refer to an interval between transmission of the PDCCH 510 to the terminal and transmission of the PDSCH 530 to the terminal in the time domain. The first offset 520 may be referred to as ‘DL assignment-to-PDSCH offset’ or ‘K0’. Meanwhile, the first DCI transmitted from the base station to the terminal through the PDCCH 510 may include information of a second offset 540. Here, the second offset 540 may refer to an interval from transmission of the PDSCH 530 to the terminal to reception of the HARQ response at the terminal through the PUCCH 550. The second offset 540 may be referred to as ‘PDSCH-to-HARQ-ACK reporting offset’ or ‘K1’.

When the base station transmits one or more downlink data units to one or more terminals through one or more PDSCHs, the one or more terminals may transmit HARQ response(s) to the base station in the same slot or different slots. For example, when the base station transmits downlink data through different PDSCHs in a plurality of different slots, the base station may adjust a second offset corresponding to each of the different PDSCHs, so that the HARQ response for each of the different PDSCHs can be received in the same slot.

The bits transmitted in the HARQ response may be defined in form of a HARQ codebook. The HARQ codebook may be generated by using a dynamic codebook scheme or a semi-static codebook scheme. In the dynamic codebook scheme, a size of the HARQ codebook may be determined based on PDSCH(s) actually scheduled for transmission of downlink data. The size of the HARQ codebook may be determined based on the number of TBs, CBs, or CBGs corresponding to the HARQ codebook. The size of the HARQ codebook may be determined based on values of a counter-DAI, a total-DAI, and the like indicated through a DAI field of DCI. The counter-DAI may be referred to as ‘c-DAI’ and may indicate the number of PDSCHs scheduled until the corresponding PDSCH is transmitted. That is, the value of the c-DAI may increase according to a scheduling result for a PDSCH in the time domain. Here, when PDSCHs are scheduled in a plurality of carriers on the same time resource, the value of the c-DAI may increase in an order of a PDSCH allocated to a carrier having a low index to a PDSCH allocated to a carrier having a high index. Meanwhile, the total-DAI may be referred to as ‘t-DAI’ and may indicate the cumulative number of PDSCHs scheduled up to the corresponding slot in units of slots. Meanwhile, in the semi-static codebook scheme, the size of the HARQ codebook may be configured to be a maximum possible value regardless of the actual PDSCH scheduling result.

Transmission of a signal from one communication node to one communication node may be referred to as point-to-point (P2P) transmission or one-to-one transmission. The P2P transmission or one-to-one transmission may be performed according to a unicast transmission scheme. Configurations described for ‘unicast transmission’ in the present specification may be applied in the same or similar manner to the P2P transmission or one-to-one transmission.

When one base station independently transmits a downlink signal to each terminal, it may be referred to as unicast downlink transmission. One or more downlink signals (hereinafter, unicast downlink signals) transmitted by the unicast downlink scheme may be transmitted from a base station to one or more terminals through independent downlink resources. At least one terminal receiving the unicast downlink signal may independently perform a HARQ response for each unicast downlink signal.

On the other hand, simultaneous transmission of the same signal from one communication node to a plurality of communication nodes may be referred to as point-to-multipoint (P2MP) transmission or one-to-many transmission. The P2MP transmission or one-to-many transmission may be performed according to a transmission scheme such as multicast, groupcast, or broadcast. Configurations described for ‘multicast transmission’ in the present specification may be applied in the same or similar manner to the P2MP transmission, one-to-many transmission, groupcast transmission, or broadcast transmission.

Simultaneous transmission of the same downlink signal from one base station to a plurality of terminals may be referred to as multicast downlink transmission. The downlink signal transmitted by the multicast downlink scheme (hereinafter, multicast downlink signal) may be transmitted from a base station to a plurality of terminals through a common downlink resource. Meanwhile, content of a HARQ response to be fed back by each of the plurality of terminals receiving the multicast downlink signal may be different from each other. Independent uplink resources may need to be allocated for the respective HARQ responses of the plurality of terminals receiving the multicast downlink signal. In the communication system, exemplary embodiments for the base station and each terminal to efficiently perform a feedback scheme configuration operation and a feedback operation in the multicast downlink transmission may be applied.

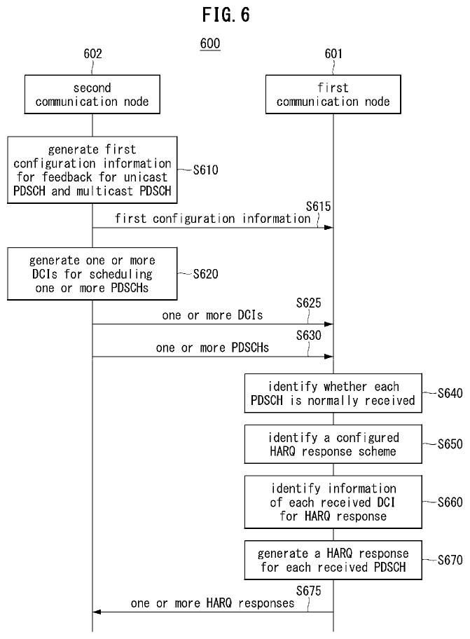

FIG. 6 is a sequence chart illustrating an exemplary embodiment of a method of transmitting and receiving a feedback signal between a first communication node and a second communication node in a communication system.

Referring to FIG. 6, a first communication node 601 may receive one or more signals from a second communication node 602. The first communication node 601 may perform a feedback operation according to whether the one or more signals transmitted from the second communication node 602 are normally received. In an exemplary embodiment of the communication system, the first communication node 601 may be configured identically or similarly to the terminals 130-1, 130-2, 130-3, 130-4, 130-5, and 130-6 described with reference to FIG. 1, the terminal 330 described with reference to FIG. 3A, the terminal 350 described with reference to FIG. 3B, the terminal described with reference to FIG. 4, and/or the one or more terminals described with reference to FIG. 5. The second communication node 602 may be configured identically or similarly to the base stations 110-1, 110-2, 110-3, 120-1, and 120-2 described with reference to FIG. 1, the base station 340 described with reference to FIG. 3A, the base station 360 described with reference to FIG. 3B, the base station described with reference to FIG. 4, and/or the base station described with reference to FIG. 5. The first communication node 601 and the second communication node 602 may be configured identically or similarly to the communication node described with reference to FIG. 2. Hereinafter, in describing an exemplary embodiment of the feedback signal transmission/reception method between the first communication node and the second communication node with reference to FIG. 6, contents overlapping with those described with reference to FIGS. 1 to 5 may be omitted.

FIG. 6 shows an exemplary embodiment of a method in which one first communication node 601 corresponding to a terminal and one second communication node 602 corresponding to a base station perform a mutual feedback signal transmission/reception procedure. However, this is only an example for convenience of description, and exemplary embodiments of the present disclosure are not limited thereto. For example, the exemplary embodiment of the communication system may be applied in the same or similar manner even when one or more base stations and one or more terminals and/or one or more terminal groups perform a mutual feedback signal transmission/reception procedure.

The second communication node 602 may generate first configuration information for a feedback operation of the first communication node 601 (S610). The second communication node 602 may transmit the first configuration information generated in the step S610 to the first communication node 601 (S615). The first communication node 601 may receive the first configuration information for the feedback operation from the second communication node 602 (S615). The first communication node 601 may perform the feedback operation on downlink data received from the second communication node 602 based on the first configuration information received from the second communication node 602. The second communication node 602 may receive a feedback signal from the first communication node 601 based on the first configuration information. For example, the second communication node 602 may use the unicast transmission scheme or multicast transmission scheme when transmitting one or more PDSCHs to the first communication node 601. The first communication node 601 may receive a PDSCH transmitted according to the unicast transmission scheme (hereinafter, referred to as ‘unicast PDSCH’) or a PDSCH transmitted according to the multicast transmission scheme (hereinafter, referred to as ‘multicast PDSCH’) from the second communication node 602. The first communication node 601 may transmit a feedback signal for one or more unicast PDSCHs or multicast PDSCHs transmitted from the second communication node 602 to the second communication node 602. Here, a feedback operation for unicast PDSCH(s) and a feedback operation for multicast PDSCH(s) may have to be performed to be differentiated from each other. The first configuration information may include one or more pieces of information for allowing the first communication node 601 to perform the feedback operation for unicast PDSCH(s) and the feedback operation for multicast PDSCH(s) to be distinguished from each other. The first configuration information may include one or more pieces of information for allowing the first communication node 601 and the second communication node 602 to operate according to at least some of the following first to seventh exemplary embodiments of the feedback signal transmission/reception method.

### Exemplary Embodiment #1 of the Feedback Signal Transmission/Reception Method

In the first exemplary embodiment of the feedback signal transmission/reception method, one or more feedback schemes may be configured between the first communication node 601 and the second communication node 602. For example, the first communication node 601 may perform feedback based on at least one of the following first to fourth feedback schemes according to whether a first signal transmitted by the second communication node 602 is normally received at the first communication node 601.

First feedback scheme: When the first signal transmitted by the second communication node 602 is normally received, the first communication node 601 may transmit a feedback signal notifying that the reception is successful. On the other hand, when the first signal is not normally received, the first communication node 601 may transmit a feedback signal notifying the reception failure. The first feedback scheme may be referred to as ‘ACK/NACK feedback scheme’ or ‘ACK/NACK HARQ scheme’.

Second feedback scheme: When the first signal transmitted by the second communication node 602 is normally received, the first communication node 601 may not transmit a separate feedback signal. On the other hand, when the first signal is not normally received, the first communication node 601 may transmit a feedback signal notifying the reception failure. The second feedback scheme may be referred to as ‘NACK-only feedback scheme’ or ‘NACK-only HARQ scheme’.

Third feedback scheme: When the first signal transmitted by the second communication node 602 is normally received, the first communication node 601 may transmit a feedback signal notifying the successful reception. On the other hand, when the first signal is not normally received, the first communication node 601 may not transmit a separate feedback. The third feedback scheme may be referred to as ‘ACK-only feedback scheme’ or ‘ACK-only HARQ scheme’.

Fourth feedback scheme: The first communication node 601 may not transmit a feedback signal regardless of whether the first signal transmitted by the second communication node 602 is normally received. The fourth feedback scheme may be referred to as ‘No Feedback scheme’ or ‘No HARQ scheme’.

The first communication node 601 may correspond to one or more terminals, and the second communication node 602 may correspond to one or more base stations. Hereinafter, the first exemplary embodiment of the feedback signal transmission/reception method will be described by exemplifying a situation in which one base station performs a mutual feedback operation with one or more terminals and/or one or more terminal groups. However, this is only an example for convenience of description, and exemplary embodiments of the present disclosure are not limited thereto.

In the communication system including the base station performing multicast downlink transmission and one or more terminals, one or more feedback schemes may be used. One or more of the first to fourth feedback schemes may be configured between the base station performing multicast downlink transmission and the one or more terminals.

The base station performing multicast downlink transmission may designate the same feedback scheme among the first to fourth feedback schemes for the one or more terminals. On the other hand, the base station performing multicast downlink transmission may designate a plurality of different feedback schemes for the one or more terminals. The base station may designate the same or different feedback schemes for terminal groups based on predetermined group identifiers capable of classifying or identifying the one or more terminals into groups. Here, the predetermined group identifier used by the base station to classify or identify the one or more terminals may be a group communication service identifier (service ID), a temporary mobile group identifier (TMGI), a group-radio network temporary identifier (G-RNTI), or the like.

The one or more terminals receiving downlink data from the base station may perform feedback to the base station based on a feedback scheme indicated for each terminal or each terminal group. For example, some of the plurality of terminals receiving downlink data may perform feedback according to the first feedback scheme and the remaining terminals may perform feedback according to the second feedback scheme. However, this is only an example for convenience of description, and exemplary embodiments of the present disclosure are not limited thereto.

The base station may receive feedback signal(s) transmitted from the one or more terminals. The base station may determine whether to retransmit the downlink signal based on the received feedback signal. The base station may not perform a retransmission operation for a terminal that transmits an ACK signal among one or more terminals to which the first feedback scheme is configured. On the other hand, the base station may perform a retransmission operation for a terminal that transmits a NACK signal among the one or more terminals to which the first feedback scheme is configured.

The base station may not perform a retransmission operation for a terminal that does not transmit a separate feedback signal among one or more terminals to which the second feedback scheme is configured. On the other hand, the base station may perform a retransmission operation for a terminal that transmits a NACK signal among the one or more terminals to which the second feedback scheme is configured.

The base station may not perform a retransmission operation for a terminal that transmits an ACK signal among one or more terminals to which the third feedback scheme is configured. On the other hand, the base station may perform a retransmission operation for a terminal that does not transmit a separate feedback signal within a predetermined time interval among the one or more terminals to which the third feedback scheme is configured.

The base station may not receive a separate feedback signal from one or more terminals to which the fourth feedback scheme is configured. The base station may not perform a separate retransmission operation for the one or more terminals to which the fourth feedback scheme is configured, even when a separate feedback signal is not received. Alternatively, the base station may perform retransmission a predetermined number of times even for the one or more terminals to which the fourth feedback scheme is configured, even when a separate feedback signal is not received.

### Exemplary Embodiment #2 of the Feedback Signal Transmission/Reception Method

In the second exemplary embodiment of the feedback signal transmission/reception method, one or more feedback schemes may be configured between the first communication node 601 and the second communication node 602. For example, the first communication node 601 may perform feedback based on at least one of first to fourth feedback schemes according to whether a first signal transmitted by the second communication node 602 is normally received by the first communication node 601. Here, the first to fourth feedback schemes may be the same as or similar to the first to fourth feedback schemes described with reference to the first exemplary embodiment of the feedback signal transmission/reception method. The first communication node 601 may correspond to one or more terminals, and the second communication node 602 may correspond to one or more base stations. Hereinafter, the second exemplary embodiment of the feedback signal transmission/reception method will be described by exemplifying a situation in which one base station performs a mutual feedback operation with one or more terminals and/or one or more terminal groups.

However, this is only an example for convenience of description, and exemplary embodiments of the present disclosure are not limited thereto. Hereinafter, in the description of the second exemplary embodiment of the feedback signal transmission/reception method, contents overlapping with those described in connection with the first exemplary embodiment of the feedback signal transmission/reception method may be omitted.

In the second exemplary embodiment of the feedback signal transmission/reception method, a base station performing multicast downlink transmission may indicate the same feedback scheme among the first to fourth feedback schemes to one or more terminals. For example, the base station may indicate one or more terminals to perform feedback according to one of the first to fourth feedback schemes through DCI transmitted to the terminal prior to a PDSCH. Alternatively, the base station may indicate one or more terminals to perform feedback according to one of the first to fourth feedback schemes through an RRC message for controlling scheduling information of a PDSCH. Alternatively, the base station may indicate one or more terminals to perform feedback according to one of the first to fourth feedback schemes while the one or more terminals perform initial access to the base station. However, this is only an example for convenience of description, and exemplary embodiments of the present disclosure are not limited thereto.

In the second exemplary embodiment of the feedback signal transmission/reception method, the base station performing multicast downlink transmission may indicate a plurality of different feedback schemes to a plurality of terminals. For example, the base station may indicate some of the plurality of terminals receiving downlink data to perform feedback according to the first feedback scheme, and indicate the remaining terminals to perform feedback according to the second feedback scheme. However, this is only an example for convenience of description, and exemplary embodiments of the present disclosure are not limited thereto. The base station may indicate a plurality of terminals to perform feedback according to a plurality of different feedback schemes through a control signal(s) such as DCI transmitted prior to a PDSCH(s). Alternatively, the base station may indicate a plurality of terminals to perform feedback according to different schemes through an RRC message(s) for controlling scheduling information of a PDSCH(s).

In the second exemplary embodiment of the feedback signal transmission/reception method, the base station performing multicast downlink transmission may indicate the same or different feedback schemes for terminal groups based on predetermined group identifiers capable of classifying or identifying one or more terminals into groups. Here, the predetermined group identifier used by the base station to classify or identify the one or more terminals may be a group communication service identifier (service ID), a temporary mobile group identifier (TMGI), or a group-radio network temporary identifier (G-RNTI). The base station may indicate a feedback scheme to one or more terminal groups based on one of a first indication scheme or a second indication scheme.

First indication scheme: The base station performing multicast downlink transmission may indicate a feedback scheme for each terminal group. The base station may classify or identify one or more terminals into one or more terminal groups based on the predetermined group identifiers. For one or more terminal groups, the base station may indicate one of the first to fourth feedback schemes to each terminal group. According to the first indication scheme, a feedback scheme may be determined for each PDSCH. The base station may dynamically indicate a feedback scheme for each terminal group through a specific field of DCI scheduling each PDSCH. Alternatively, the base station may semi-statically indicate a feedback scheme for each terminal group through an RRC message for controlling scheduling information of each PDSCH. Here, the RRC message may be defined in the same or similar form as, for example, SC-MTCH-Info-r13, which is used for single cell point-to-multipoint (SC-PTM) communication.

Second indication scheme: The base station performing multicast downlink transmission may indicate the same feedback scheme to one or more terminal groups. The base station may classify or identify one or more terminals into one or more terminal groups based on predetermined group identifiers. The base station may indicate the same feedback scheme to a plurality of terminal groups. For example, the base station may indicate terminals of first and second terminal groups among all terminal groups to perform feedback according to the same feedback scheme, and indicate terminals of third and fourth terminal groups to perform feedback according to the same feedback scheme. According to the second indication scheme, the same feedback scheme may be determined for a plurality of PDSCHs. The base station may semi-statically indicate a feedback scheme to each terminal group through an RRC message for controlling scheduling information of a plurality of PDSCHs. Here, the RRC message may be defined in the same or similar form as, for example, SCPTMConfiguration-r13 used for SC-PTM communication.

Each of one or more terminal groups may include one or more terminals. Each terminal may perform a feedback operation to the base station based on a feedback scheme determined for a terminal group to which it belongs. The base station may receive feedback signal(s) transmitted from one or more terminals. The base station may determine whether to retransmit a downlink signal based on the received feedback signal(s).

### Exemplary Embodiment #3 of the Feedback Signal Transmission/Reception Method

In the third exemplary embodiment of the feedback signal transmission/reception method, one or more feedback schemes may be configured between the first communication node 601 and the second communication node 602. For example, the first communication node 601 may perform feedback based on at least one of first to fourth feedback schemes according to whether a first signal transmitted by the second communication node 602 has been normally received by the first communication node 601. Here, the first to fourth feedback schemes may be the same as or similar to the first to fourth feedback schemes described with reference to the first exemplary embodiment of the feedback signal transmission/reception method. The first communication node 601 may correspond to one or more terminals, and the second communication node 602 may correspond to one or more base stations. Hereinafter, the third exemplary embodiment of the feedback signal transmission/reception method will be described by exemplifying a situation in which one base station performs a mutual feedback operation with one or more terminals and/or one or more terminal groups. However, this is only an example for convenience of description, and exemplary embodiments of the present disclosure are not limited thereto. Hereinafter, in the description of the third exemplary embodiment of the feedback signal transmission/reception method, contents overlapping with those described in connection with the first and/or second exemplary embodiment of the feedback signal transmission/reception method may be omitted.

In the third exemplary embodiment of the feedback signal transmission/reception method, the base station may configure or allocate uplink resources for performing feedback operations to one or more terminals. The base station may configure or allocate the uplink resources for performing the feedback operations based on a feedback scheme determined for the one or more terminals. The base station may not allocate a separate PUCCH resource to a terminal to which the fourth feedback scheme (i.e., No-HARQ scheme) is indicated.

The base station performing multicast downlink transmission may configure or allocate a common PUCCH resource for transmission of HARQ responses to one or more terminals receiving downlink data. For example, in case of transmitting the same PDSCH to one or more terminals to which the second feedback scheme (i.e., NACK-only HARQ scheme) or the third feedback scheme (i.e., ACK-only HARQ scheme) is indicated, the base station may allocate a common PUCCH resource for HARQ responses to all of the one or more terminals. In this case, a PUCCH-format0 or a PUCCH-format1 may be used as a format of a PUCCH. Here, the PUCCH-format0 may have the same or similar structure as shown in Table 2, and the PUCCH-format1 may have the same or similar structure as shown in Table 3.

TABLE 2

| PUCCH-format( ) ::= | |
|---|---|
| SEQUENCE { | |
| initialCyclicShift | INTEGER(0..11), |
| nrofSymbols | INTEGER(1..2), |
| startingSymbolIndex | INTEGER(0..13) |
| } | |

TABLE 3

| PUCCH-format1 ::= | |
|---|---|
| SEQUENCE { | |
| initialCyclicShift | INTEGER(0..11), |
| nrofSymbols | INTEGER(4..14), |
| startingSymbolIndex | INTEGER(0..10) |
| timeDomainOCC | INTEGER(0..6) |
| } | |

The PUCCH-format0 or PUCCH-format1 may be defined to include information elements (IEs) shown in Table 2 or Table 3. Alternatively, the PUCCH-format0 or PUCCH-format1 may be defined to include some of the IEs shown in Table 2 or Table 3.

On the other hand, the base station performing multicast downlink transmission may configure or allocate a different PUCCH resource for HARQ response transmission to each of one or more terminals receiving downlink data. For example, one or more terminals to which the first feedback scheme is indicated may require PUCCH resources independent from each other in order to transmit HARQ response(s) for a PDSCH. The base station may configure or allocate a different PUCCH resource for each of one or more terminals receiving the same PDSCH. In order for the base station to indicate a different PUCCH resource to each of one or more terminals receiving the same PDSCH, information for identifying each of the one or more terminals included in one terminal group may be required. For example, the base station may identify one or more terminals included in one terminal group based on a predetermined identifier(s), member IDs, or the like. The base station may allocate a different PUCCH resource to each of one or more terminals included in one terminal group based on the following first to third allocation schemes.

First allocation scheme: The base station performing multicast downlink transmission may extend and use the PUCCH-format0 shown in Table 2 or the PUCCH-format1 shown in Table 3 as a format of a PUCCH. Through this, the base station may indicate a PUCCH to occupy a plurality of resource blocks (RBs) or physical resource blocks (PRBs). Specifically, the base station may use the PUCCH-format0 or PUCCH-format1 by adding a first IE indicating the number of RBs or PRBs occupied by the PUCCH. Here, the first IE may be referred to as ‘nrofPRBs’ or the like. One or more terminals may be allocated to one RB based on the PUCCH-format0 or PUCCH-format1 extended by adding the first IE. Here, the terminals allocated to the same RB may be identified based on a predetermined identifier or code.

Second allocation scheme: The base station performing multicast downlink transmission may define and use a new format of a PUCCH for configuring or allocating a different PUCCH resource for HARQ response transmission to each of one or more terminals. For example, the base station may define and use a PUCCH format (hereinafter, ‘PUCCH-formatX’) identical to or similar as a format shown in Table 4 in order to indicate a different PUCCH resource for each of one or more terminals receiving the same PDSCH.

TABLE 4

```
PUCCH-formatX ::=
SEQUENCE {
  initialCyclicShift
  nrofSymbols
  startingSymbolIndex
  nrofPRBs
  timeDomainOCC
}
```

The PUCCH-formatX may include an RRC IE indicating the number of RBs or PRBs occupied by a PUCCH for one or more terminals to transmit HARQ response(s) to the base station. Here, the RRC IE indicating the number of RBs or PRBs occupied by the PUCCH(s) may be referred to as ‘nrofPRBs’.

-Third allocation scheme: The base station performing multicast downlink transmission may divide one or more terminals included in one terminal group into one or more subgroups, and allocate a different PUCCH resource to each subgroup. In the third allocation scheme, the base station may indicate one or more PUCCH resources to one or more terminals through one DCI. To this end, a mapping relationship between PUCCH resources and identifier(s) of the terminal groups, subgroup(s), and/or individual terminals may be configured or promised in advance between the base station and the terminal. The base station may indicate the mapping relationship to each terminal through an RRC message, MAC CE, or DCI. Each terminal may identify information of a PUCCH resource to be used for transmitting a HARQ response based on the mapping relationship indicated by the base station. Here, the PUCCH resource indicated through one DCI may be distinguished only in the frequency domain and/or the code domain, not in the time domain. Through this, one or more terminals may return HARQ response(s) to the base station using PUCCH resource(s) different in the frequency domain and/or code domain within the same slot.

### Exemplary Embodiment #4 of the Feedback Signal Transmission/Reception Method

In the fourth exemplary embodiment of the feedback signal transmission/reception method, the first communication node 601 may perform feedback based on at least one of first to fourth feedback schemes according to whether a first signal transmitted by the second communication node 602 is normally received by the first communication node 601. The first communication node 601 may correspond to one or more terminals, and the second communication node 602 may correspond to one or more base stations. Hereinafter, the fourth exemplary embodiment of the feedback signal transmission/reception method will be described by exemplifying a situation in which one base station performs a mutual feedback operation with one or more terminals and/or one or more terminal groups. However, this is only an example for convenience of description, and exemplary embodiments of the present disclosure are not limited thereto. Hereinafter, in the description of the fourth exemplary embodiment of the feedback signal transmission/reception method, contents overlapping with those described in connection with the first to third exemplary embodiments of the feedback signal transmission/reception method may be omitted.

In the fourth exemplary embodiment of the feedback signal transmission/reception method, the base station may transmit downlink data to one or more terminals. The base station may transmit downlink data to one or more terminals based on at least one of the unicast transmission scheme and the multicast transmission scheme. The base station may indicate whether the downlink data is initial transmission data or retransmission data through a new data indicator (NDI) field of DCI transmitted to the terminal prior to the downlink data transmission.

In an exemplary embodiment of the communication system, the base station may transmit downlink data to one or more terminals based on the unicast transmission scheme. In this case, the base station may indicate whether the downlink data is initial transmission date or retransmission data through a NDI field of DCI for each PDSCH. For example, when a new PDSCH is initially transmitted, the base station may toggle a value of the NDI field, and when a previously transmitted PDSCH is retransmitted, the base station may not toggle the value of the NDI field, in order to indicate whether the downlink data is initial transmission data or retransmission data. However, this is only an example for convenience of description, and exemplary embodiments of the present disclosure are not limited thereto.

In an exemplary embodiment of the communication system, the base station may transmit downlink data to one or more terminals based on the multicast transmission scheme.

In this case, the base station may indicate whether the downlink data is initial transmission data or retransmission data through a NDI field of DCI for each PDSCH.

Meanwhile, in an exemplary embodiment of the communication system, the base station may transmit downlink data to one or more terminals using both the unicast transmission scheme and multicast transmission scheme. For example, the base station may transmit some PDSCHs using the unicast transmission scheme, and transmit other PDSCHs using the multicast transmission scheme. In this case, each terminal may need to identify whether a NDI field of DCI received prior to a PDSCH indicates a PDSCH according to the unicast transmission scheme (hereinafter, referred to as ‘unicast PDSCH’) or a PDSCH according to the multicast transmission scheme (hereinafter, referred to as ‘multicast PDSCH’). The NDI field of DCI when the PDSCH is transmitted using the unicast transmission scheme and the NDI field of DCI when the PDSCH is transmitted using the multicast transmission scheme may need to be operated independently from each other. Schemes for operating the NDI field of DCI for the PDSCH transmitted by the base station in different manners may be required.

-First NDI operation scheme: The base station may operate so that the DCI for unicast PDSCH and the DCI for multicast PDSCH have different formats. The NDI fields of DCIs having different formats may be configured to operate independently of each other. The NDI fields of the DCI for unicast PDSCH and the DCI for multicast PDSCH having different DCI formats may be operated independently of each other. The terminal may identify the

NDI field of DCI for unicast PDCSH and the NDI field of DCI for multicast PDSCH based on a format of the DCI.

Second NDI operation scheme: When the format of the DCI for the PDSCH transmitted by the unicast transmission scheme and the DCI for the PDSCH transmitted by the multicast transmission scheme are the same, types of RNTIs by which CRCs are scrambled may be configured to be different from each other, so that the DCI can be distinguished from each other. The terminal may distinguish between the NDI field of DCI for unicast PDCSH and the NDI field of DCI for multicast PDSCH based on the types of RNTIs by which the CRCs in the DCI are scrambled.

Based on the first or second NDI operation scheme, the base station may independently operate the NDI field of the DCI for scheduling the unicast PDSCH and the NDI field of the DCI for scheduling the multicast PDSCH. For example, the NDI field of the DCI scheduling the unicast PDSCH may be toggled based only on whether the unicast PDSCH is initially transmitted or retransmitted. Meanwhile, the NDI field of the DCI scheduling the multicast PDSCH may be toggled based only on whether the multicast PDSCH is initially transmitted or retransmitted.

### Exemplary Embodiment #5 of the Feedback Signal Transmission/Reception Method

In the fifth exemplary embodiment of the feedback signal transmission/reception method, the first communication node 601 may perform feedback based on at least one of first to fourth feedback schemes according to whether a first signal transmitted by the second communication node 602 has been normally received by the first communication node 601. The first communication node 601 may correspond to one or more terminals, and the second communication node 602 may correspond to one or more base stations. Hereinafter, the fifth exemplary embodiment of the feedback signal transmission/reception method will be described by exemplifying a situation in which one base station performs a mutual feedback operation with one or more terminals and/or one or more terminal groups. However, this is only an example for convenience of description, and exemplary embodiments of the present disclosure are not limited thereto. Hereinafter, in the description of the fifth exemplary embodiment of the feedback signal transmission/reception method, contents overlapping with those described in connection with the first to fourth exemplary embodiments of the feedback signal transmission/reception method may be omitted.

In the fifth exemplary embodiment of the feedback signal transmission/reception method, the base station may transmit downlink data to one or more terminals. The base station may transmit downlink data to one or more terminals based on at least one of the unicast transmission scheme and the multicast transmission scheme. The base station may indicate an order or index of a HARQ response to be transmitted by a terminal through a HARQ process number (HPN) field of DCI transmitted to the terminal prior to the downlink data transmission. When the HPN field has a size of n bits, a maximum of 2ⁿ distinct HPN values may be indicated. For example, as shown in Table 1, the HPN field of the DCI may have a size of 4 bits, and in this case, a maximum of 16 HPN values distinguished from each other may be indicated. In other words, when the HPN field has a size of 4 bits, it may be considered that HARQ process capability or HARQ process capability corresponds to 16. However, this is only an example for convenience of description, and exemplary embodiments of the present disclosure are not limited thereto.

In an exemplary embodiment of the communication system, the base station may transmit downlink data to one or more terminals based on the unicast transmission scheme. In this case, since each terminal independently receives a PDSCH from each other, each terminal may receive an HPN indication independently from each other.

In an exemplary embodiment of the communication system, the base station may transmit downlink data to one or more terminals based on the multicast transmission scheme.

In this case, one or more terminals receiving the same PDSCH may all be indicated by the same HPN through DCI received prior to the PDSCH.

Meanwhile, in an exemplary embodiment of the communication system, the base station may transmit downlink data to one or more terminals using both the unicast transmission scheme and multicast transmission scheme. For example, the base station may transmit some PDSCHs using the unicast transmission scheme, and transmit other PDSCHs using the multicast transmission scheme. In this case, each terminal may need to identify whether the HPN field of the DCI received prior to the PDSCH indicates a unicast PDSCH or a multicast PDSCH. When the base station transmits PDSCHs in different schemes, HPN operation schemes for allowing the terminal to distinguish between HPN information for the unicast PDSCH and HPN information for the multicast PDSCH may be required.

First HPN operation scheme: The base station may operate the HPN fields of the DCI for the unicast PDSCH and the DCI for the multicast PDSCH by distinguishing between them. In this case, the HPN field of DCI for the unicast PDSCH may indicate only the index of the HARQ process for the unicast PDSCH, and the HPN field of the DCI for the multicast

PDSCH may indicate only the index of the HARQ process for the multicast PDSCH.

Second HPN operation scheme: The base station may use a portion of the HARQ process capability determined according to the size of the HPN field of the DCI for unicast PDSCH(s) and may use the remaining portion of the HARQ process capability for multicast PDSCH(s). If the HPN field has a size of n bits, a maximum of 2ⁿ distinct HPN values may be indicated. Here, the base station may use X HPN values for unicast PDSCH(s), and 2ⁿ-X HPN values for multicast PDSCH(s). For example, when the HPN field has a size of 4 bits, the base station may use HPNs 0 to 7 out of 16 HPNs for unicast PDSCH(s), and HPNs 8 to 15 may be used for multicast PDSCH(s). In this case, when the HPN field of the DCI indicates any one value from 0 to 7, the terminal may determine that the HPN field indicates a HPN for a unicast PDSCH, and when the HPN field of the DCI indicates any one value from 8 to 15, the terminal may determine that the HPN field indicates a HPN for a multicast PDSCH.

### Exemplary Embodiment #6 of the Feedback Signal Transmission/Reception Method

In the sixth exemplary embodiment of the feedback signal transmission/reception method, the first communication node 601 may perform feedback based on at least one of first to fourth feedback schemes according to whether a first signal transmitted by the second communication node 602 has been normally received by the first communication node 601. The first communication node 601 may correspond to one or more terminals, and the second communication node 602 may correspond to one or more base stations. Hereinafter, the sixth exemplary embodiment of the feedback signal transmission/reception method will be described by exemplifying a situation in which one base station performs a mutual feedback operation with one or more terminals and/or one or more terminal groups. However, this is only an example for convenience of description, and exemplary embodiments of the present disclosure are not limited thereto. Hereinafter, in the description of the sixth exemplary embodiment of the feedback signal transmission/reception method, contents overlapping with those described in connection with the first to fifth exemplary embodiments of the feedback signal transmission/reception method may be omitted.

In the sixth exemplary embodiment of the feedback signal transmission/reception method, the base station may transmit downlink data to one or more terminals. The base station may transmit downlink data to one or more terminals based on at least one of the unicast transmission scheme and the multicast transmission scheme. The base station may indicate the number of HARQ response signals transmitted in one slot through a downlink assignment index (DAI) field of DCI transmitted to the terminal prior to the downlink data transmission. Bits transmitted in the HARQ response may be defined in form of a HARQ codebook. The HARQ codebook may be configured based on information indicated through the DAI field.

The base station may transmit unicast PDSCH(s) to one or more terminals. Each terminal may receive a unicast PDSCH that is distinguished from another PDSCH from the base station. At least one terminal receiving the unicast PDSCH from the base station may receive a DAI value that is distinguished from another through a corresponding DCI.

The base station may transmit a multicast PDSCH to one or more terminals. One or more terminals may receive the same multicast PDSCH from the base station. One or more terminals receiving the same multicast PDSCH from the base station may receive the same DAI value through a corresponding DCI.

On the other hand, the base station may transmit unicast PDSCH(s) and a multicast PDSCH together. In this case, each terminal may receive either the unicast PDSCH or the multicast PDSCH from the base station, or may receive both the unicast PDSCH and the multicast PDSCH. A terminal receiving both the unicast PDSCH and the multicast PDSCH may transmit a HARQ response for each of the received unicast PDSCH and multicast

PDSCH in the same slot. In this case, a HARQ codebook may include all bits of the HARQ responses for both the unicast PDSCH and the multicast PDSCH. For the HARQ response transmission of the terminal receiving both the unicast PDSCH and the multicast PDSCH, the base station may operate the DAI field of the DCI according to the following first and second DAI operation schemes.

First DAI operation scheme: In determining the value of the DAI field of the DCI scheduling the unicast PDSCH, the base station may reflect a scheduling result of the unicast PDSCH and a scheduling result of the multicast PDSCH together. For example, the value of the c-DAI in the DAI field of the DCI scheduling the unicast PDSCH may be determined as a sum of the numbers of unicast PDSCHs and multicast PDSCHs scheduled until the corresponding unicast PDSCH is transmitted in the time domain. In addition, the value of the t-DAI in the DAI field of the DCI scheduling the unicast PDSCH may be determined as a sum of the accumulated number of unicast PDSCHs and the accumulated number of multicast PDSCHs scheduled up to the corresponding slot in units of slots.

Second DAI operation scheme: The terminal may perform HARQ response for the unicast PDSCH or the multicast PDSCH regardless of the DAI value of the DCI field for the multicast PDSCH. For example, in the process of generating the codebook for the HARQ response of the terminal, the DAI value of the DCI field for the multicast PDSCH may not be considered. Alternatively, the base station may not include the DAI field when transmitting the DCI for the multicast PDSCH to the terminal.

### Exemplary Embodiment #7 of the Feedback Signal Transmission/Reception Method

In the seventh exemplary embodiment of the feedback signal transmission/reception method, the first communication node 601 may perform feedback based on at least one of first to fourth feedback schemes according to whether a first signal transmitted by the second communication node 602 has been normally received by the first communication node 601.

The first communication node 601 may correspond to one or more terminals, and the second communication node 602 may correspond to one or more base stations. Hereinafter, the seventh exemplary embodiment of the feedback signal transmission/reception method will be described by exemplifying a situation in which one base station performs a mutual feedback operation with one or more terminals and/or one or more terminal groups. However, this is only an example for convenience of description, and exemplary embodiments of the present disclosure are not limited thereto. Hereinafter, in the description of the seventh exemplary embodiment of the feedback signal transmission/reception method, contents overlapping with those described in connection with the first to sixth exemplary embodiments of the feedback signal transmission/reception method may be omitted.

The base station may transmit unicast PDSCH(s) to one or more terminals. Each terminal may receive a unicast PDSCH that is distinguished from another PDSCH from the base station. Each of the one or more terminal receiving the unicast PDSCH(s) from the base station may transmit a HARQ response through a PUCCH resource indicated by a corresponding DCI.

The base station may transmit a multicast PDSCH to one or more terminals. One or more terminals may receive the same multicast PDSCH from the base station. One or more terminals receiving the same multicast PDSCH from the base station may transmit HARQ response(s) through PUCCH resources indicated by a corresponding DCI.

On the other hand, the base station may transmit unicast PDSCH(s) and a multicast PDSCH together. In this case, each terminal may receive either the unicast PDSCH or the multicast PDSCH from the base station, or may receive both the unicast PDSCH and the multicast PDSCH. A terminal receiving any one type PDSCH among the unicast PDSCH and the multicast PDSCH from the base station may transmit a HARQ response through a PUCCH resource indicated through a corresponding DCI.

When the terminal receives both the unicast PDSCH and the multicast PDSCH, the terminal may transmit a HARQ response for the unicast PDSCH through a PUCCH resource indicated by DCI for the unicast PDSCH, and transmit a HARQ response for the multicast PDSCH through a PUCCH resource indicated by DCI for the multicast PDSCH. Here, if a timing of the PUCCH resource indicated by the DCI for the unicast PDSCH is identical to a timing of the PUCCH resource indicated by the DCI for the multicast PDSCH, the terminal may transmit both the HARQ responses for the unicast PDSCH and the multicast PDSCH through the PUCCH resource indicated by the DCI for the unicast PDSCH. To this end, a separate type of PUCCH or HARQ response may be defined and used. Here, even when the terminal is indicated the second or third feedback scheme as a HARQ response scheme for the multicast PDSCH, the terminal may generate a feedback signal for the multicast PDSCH based on the first feedback scheme instead of the second or third feedback scheme. For example, when the terminal is indicated the NACK-only HARQ scheme as a HARQ response scheme for the multicast PDSCH, if the terminal wants to transmit HARQ responses for the unicast PDSCH and the multicast PDSCH through the same PUCCH resource, the terminal may generate a HARQ codebook so that both the HARQ responses for the unicast PDSCH and the multicast PDSCH are generated according to the ACK/NACK HARQ feedback scheme. The terminal may transmit an ACK response or NACK response for the unicast PDSCH and an ACK response or NACK response for the multicast PDSCH to the base station based on the generated HARQ codebook.

In the step S610 of FIG. 6, the second communication node 602 may generate first configuration information instructing the first communication node 601 to perform the feedback operations for the unicast PDSCH and the multicast PDSCH to be distinguished from each other according to at least some of the first to seventh exemplary embodiments of the feedback signal transmission/reception method. For example, the second communication node 602 may generate the first configuration information including configuration information of a first PUCCH format for the feedback operation for unicast PDSCH(s), and configuration information of a second PUCCH format for the feedback operation for multicast PDSCH(s). Here, the configuration information of the first PUCCH format and the configuration information of the second PUCCH format may be configured based on the third exemplary embodiment of the feedback signal transmission/reception method. The second communication node 602 may transmit the first configuration information generated in the step S610 to the first communication node 601. The first communication node 601 may receive the first configuration information for the feedback operations from the second communication node 602 (S615).

The second communication node 602 may generate one or more control signals for scheduling one or more signals to be transmitted to the first communication node 601 (S620). In an exemplary embodiment of the communication system, the one or more signals to be transmitted by the second communication node 602 to the first communication node 601 may correspond to one or more downlink data units or one or more PDSCHs. The one or more control signals generated by the second communication node 602 in the step S620 may correspond to one or more DCIs for scheduling the one or more PDSCHs. The one or more DCIs generated in the step S620 may be generated by the second communication node 602 based on at least some of the first to seventh exemplary embodiments of the above-described feedback signal transmission/reception method. The second communication node 602 may transmit the one or more DCIs generated in the step S620 to the first communication node 601 (S625). The first communication node 601 may receive the one or more DCIs transmitted from the second communication node 602 (S625).

The second communication node 602 may transmit the one or more signals to the first communication node 601 based on the one or more control signals transmitted in the step S625 (S630). In an exemplary embodiment of the communication system, the first communication node 601 may receive the one or more signals transmitted from the second communication node 602 based on the one or more control signals received in the step S625 (S630). In an exemplary embodiment of the communication system, the one or more signals transmitted from the second communication node 602 to the first communication node 601 may correspond to the one or more PDSCHs transmitted from the base station to the terminal. Each of the one or more signals transmitted from the second communication node 602 to the first communication node 601 may correspond to one of a PDSCH transmitted by the base station according to the unicast transmission scheme (hereinafter, unicast PDSCH) and a PDSCH transmitted by the base station according to the multicast transmission scheme (hereinafter, multicast PDSCH). However, this is only an example for convenience of description, and exemplary embodiments of the present disclosure are not limited thereto.

The first communication node 601 may identify whether each of the one or more signals transmitted from the second communication node 602 is normally received (S640). For example, the first communication node 601 may attempt to decode the one or more signals transmitted from the second communication node 602. Here, the first communication node 601 may determine a successfully-decoded signal as normally-received data. On the other hand, the first communication node 601 may determine a signal for which decoding fails as not normally received data.

The first communication node 601 may identify a feedback scheme configured to itself (S650). For example, in an exemplary embodiment of the communication system, the first communication node 601 may be configured with any one of the first to fourth feedback schemes described with reference to the first exemplary embodiment of the feedback signal transmission/reception method. The first communication node 601 may identify the feedback scheme indicated by the second communication node 602 in the same or similar manner as described with reference to the second exemplary embodiment of the feedback signal transmission/reception method. For example, the second communication node 602 may configure one of the first to fourth feedback schemes to the first communication node 601 through the first configuration information, one or more DCIs and/or an RRC message that controls scheduling information of one or more PDSCHs. If it is identified that the first feedback scheme (i.e., ACK/NACK HARQ scheme) is configured to the first communication node 601, the first communication node 601 may determine that transmission of an ACK signal or NACK signal indicating a reception success or failure identified in the step S640 is required. If it is identified that the second feedback scheme (i.e., NACK-only HARQ scheme) is configured to the first communication node 601, the first communication node 601 may determine that transmission of a NACK signal only for a signal not normally received in the step S640 is required. If it is identified that the third feedback scheme (i.e., ACK-only HARQ scheme) is configured to the first communication node 601, the first communication node 601 may determine that transmission of an ACK signal only for a signal normally received in the step S640 is required. If it is identified that the fourth feedback scheme (i.e., No-HARQ scheme) is configured to the first communication node 601, the first communication node 601 may determine that transmission of a HARQ response is not required. However, this is only an example for convenience of description, and exemplary embodiments of the present disclosure are not limited thereto.

If it is determined that there is no need to transmit a feedback signal to the second communication node 602 according to the results of determinations in the steps S640 and S650, the first communication node 601 may terminate the feedback procedure without an additional operation. On the other hand, if it is determined that it is necessary to transmit a feedback signal to the second communication node 602 according to the results of determinations in the steps S640 and S650, the first communication node 601 may identify information of each of the one or more control signals received in the step S615. For example, when it is determined that it is necessary to transmit feedback signal(s) for the one or more PDSCHs in the steps S640 and S650, the first communication node 601 may identify one or more pieces of information included in each of the one or more DCIs corresponding to the one or more PDSCHs for which transmission of feedback signal(s) is determined to be required (S660).

Specifically, in order to transmit HARQ response(s) for the one or more PDSCHs for which transmission of feedback signal(s) is required, the first communication node 601 may identify information of a PUCCH resource allocated through DCI transmitted for scheduling each PUSCH. Here, the PUCCH resource information may refer to information on a

PUCCH resource allocated to the first communication node 601 by the second communication node 602 in the same or similar manner as described with reference to the third exemplary embodiment of the feedback signal transmission/reception method.

Meanwhile, the first communication node 601 may identify information of one or more fields included in each DCI transmitted from the second communication node 602 to the first communication node 601 for scheduling a PDSCH. Each DCI may include some or all of the NDI field, the HPN field, and the DAI field. Here, information of the NDI field may be configured according to the same or similar method as described with reference to the fourth exemplary embodiment of the feedback signal transmission/reception method. Information in the HPN field may be configured according to the same or similar method as described with reference to the fifth exemplary embodiment of the feedback signal transmission/reception method. Information of the DAI field may be configured according to the same or similar method as described with reference to the sixth exemplary embodiment of the feedback signal transmission/reception method.

The first communication node 601 may generate one or more feedback signals for the one or more signals transmitted from the second communication node 602 according to the results of the identifying operations in the steps S640 to S660 (S670). The first communication node 601 may transmit the one or more generated feedback signals to the second communication node 602 (S675). For example, the first communication node 601 may generate one or more HARQ responses for one or more PDSCHs for which transmission of feedback signal(s) is determined to be required among the one or more PDSCHs received in the step S630, according to the results of the identifying operations of the steps S640 to S660. The first communication node 601 may transmit the one or more HARQ responses generated in the step S670 to the second communication node 602 based on the one or more PUCCH resources indicated by the one or more DCIs received in step S625. Here, the first communication node 601 may perform the feedback signal transmission to the first communication node 602 according to whether the signal transmitted from the second communication node has been transmitted according to the unicast transmission scheme or the multicast transmission scheme. For example, the first communication node 601 may generate the feedback signal or transmit the generated feedback signal to the second communication according to the same or similar method as described with reference to at least some of the first to seventh exemplary embodiments of the feedback signal transmission/reception method. The second communication node 602 may monitor the one or more PUCCH resources indicated by the one or more DCIs transmitted in the step S625, and may receive the one or more feedback signals transmitted from the first communication node 601 (S675). The second communication node 602 may determine whether a retransmission operation is required for the first communication node 601 based on the one or more received feedback signals. For example, when the second communication node 602 receives one or more NACK signals from the first communication node 601, the second communication node 602 may retransmit one or more PDSCHs corresponding to the received one or more NACK signals to the first communication node 601.

The first communication node 601 and the second communication node 602 may perform a mutual feedback procedure based on the same or similar operations as the steps S610 to S675. The first communication node 601 may perform feedback operation(s) for the unicast PDSCH and/or the multicast PDSCH that the second communication 602 transmitted for the first communication node 601 and/or a first terminal group including the first communication node 601. The second communication node 602 may receive feedback signal(s) for the unicast PDSCH and/or the multicast PDSCH transmitted to the first terminal group including the first communication node 601 and/or the first communication node 601. In addition to the first communication node 601 and/or the first terminal group, the second communication node 602 may transmit a unicast PDSCH and/or a multicast PDSCH to one or more other communication nodes and/or one and/or one or more other terminal groups. The second communication node 602 may receive feedback signal(s) for the PDSCH(s) transmitted to the one or more communication nodes and/or the one or more terminal groups. The second communication node 602 may perform the feedback procedure with the one or more communication nodes and/or the one or more terminal groups based on the same or similar configurations as those described with reference to FIG. 6.

According to an exemplary embodiment of the present disclosure, a base station may use either the unicast transmission scheme or the multicast transmission scheme, or use both the unicast transmission scheme and the multicast transmission scheme when transmitting downlink data to a terminal. The base station may indicate the terminal of information for the terminal to perform a feedback operation on the downlink data transmitted according to the unicast transmission scheme or the multicast transmission scheme through DCI for scheduling the downlink data transmitted to the terminal. Accordingly, the feedback operation between the base station and the terminal supporting both the unicast transmission scheme and the multicast transmission scheme can be efficiently performed.

However, the effects that can be achieved by the method and apparatus for controlling multi-connectivity in the wireless communication system according to the exemplary embodiments of the present disclosure are not limited to those mentioned above, and other effects not mentioned may be clearly understood by those of ordinary skill in the art to which the present disclosure belongs from the configurations described in the present disclosure.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. A method for transmitting a feedback signal, performed by a first terminal in a communication system, the method comprising:
receiving first configuration information from a first base station in the communication system, the first configuration information including configuration information of a first physical uplink control channel (PUCCH) format for feedback for a unicast transmission scheme and configuration information of a second PUCCH format for feedback for a multicast transmission scheme;
receiving first downlink control information (DCI) for scheduling first downlink data from the first base station;
receiving the first downlink data from the first base station based on the first configuration information and the first DCI; and
performing a feedback operation for the first down data to the first base station based on the first configuration information and the first DCI,
wherein the receiving of the first DCI and the performing of the feedback operation for the first downlink data are performed differently for a case when the first downlink data is downlink data transmitted according to the unicast transmission scheme and a case when the first downlink data is downlink data transmitted according to the multicast transmission scheme.

2. The method according to claim 1, wherein the performing of the feedback operation for the first downlink data comprises:
when the first downlink data is downlink data transmitted according to the multicast transmission scheme, identifying information of resource blocks (RBs) of a first PUCCH allocated to the first terminal among a plurality of PUCCH RBs allocated by the first DCI separately to a plurality of terminals included in a first terminal group including the first terminal; and
transmitting a first feedback signal for the first downlink data to the first base station through the RBs of the first PUCCH.

3. The method according to claim 2, wherein the second PUCCH format is defined to include a first information element (IE) allowing a PUCCH to be allocated to a plurality of RBs.

4. The method according to claim 1, wherein the performing of the feedback operation for the first downlink data comprises:
when the first downlink data is downlink data transmitted according to the multicast transmission scheme, identifying information of resources of a first PUCCH allocated to a first subgroup including the first terminal among a plurality of PUCCH resources allocated by the first DCI separately to a plurality of subgroups into which a first terminal group including the first terminal is divided; and
transmitting a first feedback signal for the first downlink data to the first base station through the resources of the first PUCCH.

5. The method according to claim 1, wherein the receiving of the first DCI comprises identifying whether a new data indicator (NDI) field of the first DCI indicates whether downlink data transmitted according to the unicast transmission scheme is initial transmission data or whether downlink data transmitted according to the multicast transmission scheme is initial transmission data based on a DCI format of the first DCI or a type of a radio network temporary identifier (RNTI) scrambling a cyclic redundancy check (CRC) of the first DCI.

6. The method according to claim 1, wherein the receiving of the first DCI comprises identifying whether a hybrid automatic repeat request (HARQ) process number (HPN) field of the first DCI indicates information related to a HARQ process(es) of downlink data transmitted according to the unicast transmission scheme or information related to a HARQ process(es) of downlink data transmitted according to the multicast transmission scheme based on a HPN value indicated by the HPN field of the first DCI, wherein n HPN values among N HPN values indicatable by the HPN field are used to indicate the information related to the HARQ process(es) of downlink data transmitted according to the unicast transmission scheme, and remaining (N-n) HPN values are used to indicate the information related to the HARQ process(es) of downlink data transmitted according to the multicast transmission scheme.

7. The method according to claim 1, wherein the receiving of the first DCI comprises, when the first downlink data is downlink data transmitted according to the multicast transmission scheme, obtaining, through a value of a downlink assignment index (DAI) field of the first DCI, a counter DAI (c-DAI) value and a total DAI (t-DAI) value reflecting a result of downlink data scheduling according to the unicast transmission scheme and a result of downlink data scheduling according to the multicast transmission scheme up to a time when the first downlink data is scheduled.

8. The method according to claim 1, wherein the first DCI corresponds to a DCI defined not to include a DAI field when the first downlink data is downlink data transmitted according to the multicast transmission scheme.

9. The method according to claim 1, further comprising, when the first downlink data is downlink data transmitted according to the unicast transmission scheme, receiving, from the first base station, second DCI for scheduling second downlink data to be transmitted according to the multicast transmission scheme;
receiving, from the first base station, the second downlink data based on the first configuration information and the second DCI; and
performing a feedback operation for the second downlink data to the first base station based on the first configuration information and the second DCI,
wherein when a timing of a first PUCCH resource indicated by the first DCI for a feedback procedure for the first downlink data transmitted according to the unicast transmission scheme is identical to a timing of a second PUCCH resource indicated by the second DCI for a feedback procedure for the second downlink data transmitted according to the multicast transmission scheme, the feedback operation for the first downlink data and the feedback operation for the second downlink data are both performed through a first PUCCH resource.

10. The method according to claim 9, wherein in the performing of the feedback operation for the second downlink data, when the first terminal is indicated a negative acknowledgement (NACK)-only HARQ scheme as a feedback scheme for performing a feedback procedure for downlink data transmitted according to the multicast transmission scheme, the feedback operation for the second downlink data is performed according to an ACK/NACK HARQ scheme instead of the indicated NACK-only HARQ scheme.

11. The method according to claim 1, wherein the performing of the feedback operation for the first down data comprises:
when the first downlink data is downlink data transmitted according to the multicast transmission scheme, determining whether feedback signal transmission for the first downlink data is required based on a first feedback scheme indicated by the first base station before transmission of the first downlink data and whether the first downlink data is normally received;
generating a first feedback signal for the first downlink data when the feedback signal transmission for the first downlink data is required; and
transmitting the first feedback signal to the first base station,
wherein the first feedback scheme is indicated selectively among an ACK/NACK HARQ scheme, NACK-only HARQ scheme, ACK-only HARQ scheme, and no-HARQ scheme through the first configuration information, the first DCI, or a radio resource control (RRC) message controlling scheduling information of the first downlink data.

12. A method for receiving a feedback signal, performed by a first base station in a communication system, the method comprising:
transmitting first configuration information to a plurality of terminals in the communication system, the first configuration information including configuration information of a first physical uplink control channel (PUCCH) format for feedback for a unicast transmission scheme and configuration information of a second PUCCH format for feedback for a multicast transmission scheme;
transmitting first downlink control information (DCI) for scheduling first downlink data to at least one terminal among the plurality of terminals;
transmitting the first downlink data to the at least one terminal based on the first configuration information and the first DCI; and
receiving at least one feedback signal for the first downlink data from the at least one terminal based on the first configuration information and the first DCI,
wherein the transmitting of the first DCI and the receiving of the at least one feedback signal are performed in difference schemes for a case when the first downlink data is downlink data transmitted according to the unicast transmission scheme and a case when the first downlink data is downlink data transmitted according to the multicast transmission scheme.

13. The method according to claim 12, wherein the first DCI is configured to allocate a plurality of PUCCH resource blocks (RBs) to be separately allocated to each of a plurality of terminals included in a first terminal group of the communication system when the first downlink data is downlink data transmitted according to the multicast transmission scheme, and the receiving of the at least one feedback signal comprises:
identifying the plurality of PUCCH RBs allocated based on the first DCI; and
receiving the at least one feedback signal for the first downlink data from at least a part of the plurality of terminals included in the first terminal group through at least a part of the plurality of PUCCH RBs.

14. The method according to claim 12, wherein the second PUCCH format is defined to include a first information element (IE) allowing a PUCCH to be allocated to a plurality of RBS.

15. The method according to claim 12, wherein DCI for scheduling downlink data transmitted according to the unicast transmission scheme and DCI for scheduling downlink data transmitted according to the multicast transmission scheme are configured based on different DCI formats, and the first base station operates new data indicator (NDI) fields of the DCIs configured based on different DCI formats independently from each other.

16. The method according to claim 12, wherein in DCI for scheduling downlink data transmitted according to the unicast transmission scheme and downlink data transmitted according to the multicast transmission scheme, the first base station uses n hybrid automatic repeat request (HARQ) process number (HPN) values among N HPN values indicatable by a HPN field to indicate information related to a HARQ process(es) of the downlink data transmitted according to the unicast transmission scheme, and uses remaining (N-n) HPN values to indicate information related to a HARQ process(es) of the downlink data transmitted according to the multicast transmission scheme.

17. The method according to claim 12, wherein the first base station operates HPN fields of DCI for scheduling downlink data transmitted according to the unicast transmission scheme and DCI for scheduling downlink data transmitted according to the multicast transmission scheme independently from each other.

18. The method according to claim 12, wherein the transmitting of the first DCI comprises:
when the first downlink data is downlink data transmitted according to the multicast transmission scheme, identifying a result of downlink data scheduling according to the unicast transmission scheme and a result of downlink data scheduling according to the multicast transmission scheme up to a time when the first downlink data is scheduled; and
determining a counter downlink assignment index (c-DAI) value and a total DAI (t-DAI) value of a DAI field of the first DCI by reflecting the identified result of downlink data scheduling according to the unicast transmission scheme and the identified result of downlink data scheduling according to the multicast transmission scheme.

19. The method according to claim 12, further comprising, when the first downlink data is downlink data transmitted to the first terminal according to the unicast transmission scheme,
transmitting, to a first terminal group including the first terminal, second DCI for scheduling second downlink data to be transmitted according to the multicast transmission scheme;
transmitting, to a plurality of terminals included in the first terminal group, the second downlink data based on the first configuration information and the second DCI; and
receiving at least one feedback signal for the second downlink data from at least a part of the plurality of terminals included in the first terminal group based on the first configuration information and the second DCI,
wherein when a timing of a first PUCCH resource indicated by the first DCI for a feedback procedure for the first downlink data transmitted according to the unicast transmission scheme is identical to a timing of a second PUCCH resource indicated by the second DCI for a feedback procedure for the second downlink data transmitted according to the multicast transmission scheme, the at least one feedback signal for the first downlink data and the at least one feedback signal for the second downlink data are received through a first PUCCH resource.

20. The method according to claim 12,
wherein the first base station indicates feedback scheme(s) to a plurality of terminal groups through the first configuration information, a plurality of DCIs scheduling a plurality of downlink data units, or a plurality of radio resource control (RRC) messages controlling scheduling information of the plurality of downlink data units before transmitting the plurality of downlink data units to the plurality of terminal groups, and
wherein the feedback scheme(s) are selected among an ACK/NACK HARQ scheme, NACK-only HARQ scheme, ACK-only HARQ scheme, and no-HARQ scheme, and the feedback scheme(s) are indicated independently to each of the plurality of terminal groups or indicated identically to at least two of the plurality of terminal groups.
